(19) United States
(12) Patent Application Publication
(10) Pub. No.: US 2005/0261929 A1
(43) Pub. Date: Nov. 24, 2005

(54) Method, apparatus and article for tracking and/or rewarding third parties within a networked commercial environment

(75) Inventors: Keith M. Hansen, Woodinville, WA (US); Lonnie C.M. Kyser, Kenmore, WA (US); Larry K. Cragun, Issaquah, WA (US); Glen L. Hansen, Redmond, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: IronTrack Hosting, LLC, Bellevue, WA (US)

(21) Appl. No.: 11/027,762

(22) Filed: Dec. 30, 2004

Related U.S. Application Data
(60) Provisional application No. 60/533,306, filed on Dec. 30, 2003.

(51) Int. Cl. G06F 17/60

(52) U.S. Cl. 705/1

(57) ABSTRACT

Tracking the origination, and/or the series of referring parties allows adequate, accurate and timely recognition of referrals or leads, fostering increased cooperation between parties. An trusted intermediary may expeditiously track or monitor the referrals or leads further enhancing cooperation between parties, allowing the successful implementation of new business models. Broadcasting the availability of a lead to multiple agents having suitable criteria increases the responsiveness to consumer inquires or leads.

### CROSS REFERENCE TO RELATED APPLICATIONS

This application claims benefit under 35 U.S.C. 119(e) from U.S. provisional patent application Ser. No. 60/533,306, filed Dec. 30, 2003.

### BACKGROUND OF THE INVENTION

1. Field of the Invention

The methods, apparatus and articles described herein are generally related to tracking and/or awarding third parties who originate or otherwise provide leads that may consummate in a consumer transaction, and facilitating timely responses to the referral of leads.

2. Description of the Related Art

The Internet allows the providers of goods and/or services the ability to reach potential consumers directly in unprecedented ways. Conversely, the Internet provides potential consumers new ways to research and shop for goods and/or services, and to find providers of such goods and/or services. This new medium gives rise to new consumer behaviors, resulting in new demands upon the providers who serve such consumers.

One example of the many possible examples may be instructive. The consumer may, for example, be brought into the “door” of one provider (e.g., the provider's Website or Webpage), then led to the “door” of another provider (e.g., via a link to a second provider's Website or Webpage), and then led to the “door” of yet another provider, while all the time maintaining complete freedom to “browse” and research. In this example, the originator of the consumer inquiry (i.e., lead) will in most cases not be the service provider of the lead or the ultimate provider of the purchased goods and/or services.

When a potential consumer is interested in more information on a particular good and/or service, the consumer may desire immediate assistance or may request assistance at some later time. The consumer commonly expects more knowledgeable assistance when they indicate they are ready for help and/or more information.

In order for businesses to keep pace with the demands of the consumer, businesses must adapt or evolve the way in which they conduct business. Specifically, businesses must change the way they obtain, distribute, and manage their consumer inquiries.

One way these demands can be met is through the creation of new business relationships by the providers of goods and/or services. One of the many possible examples of such a relationship is a group of real estate companies, or offices, and/or agents affiliating themselves into a network of other real estate companies, or offices, and/or agents to combine their collective resources and people, to the mutual benefit of each other. The affiliation of these third party entities within a network is synergistic for these entities.

Another way these demands can be met is through the creation of new people and financial processes used by the providers of goods and/or services to capture revenue from these consumer inquiries. As an example, currently, the multi-billion dollar real estate industry is experiencing revolutionary change. The use of the Internet, and particularly the World Wide Web portion of the Internet, as a shopping tool for home buyers (consumers) is exploding. According to statistics from the National Association of Realtors® (NAR), 38% of home buyers used the Internet as a research tool just a few years ago; while today 72% of home buyers use the Internet as a research tool. Home buyers who do not use the Internet look at an average of 18 to 20 homes with an Agent before purchasing, while home buyers who use the Internet look at an average of 6 to 7 homes with an Agent before purchasing. Home buyers who use the Internet expect convenience in searching for homes, and researching schools, communities and areas. Home buyers who use the Internet also demand a fast and professional response when they are ready to look at a home. The providers that adapt to the consumer trends such examples represent, will be those who will prosper and grow in this new market place. Such adaptation must include serving the changes in consumer behavior and the naturally resulting needs.

A common approach has been for company/agent A to place a call to company/agent B to refer a prospective consumer. Company/agent B then pays company/agent A for the lead, or an agreed upon portion of the resulting sale or commission of the sale. As online systems came to the market, there have been many creative proposals for automating portions of the referral procedure. For example, company/agent A enters a lead into the system where company/agent B picks the lead up and updates the system with the follow through results after contacting the consumer, etc. What is inherent with these partially automated systems is the manual entry of the leads into the system, allowing such leads to be tracked.

### BRIEF SUMMARY OF THE DISCLOSURE

One previously unrecognized problem in successfully realizing the above described approaches is the inability or difficulty in compensating or otherwise awarding the lead originator for their investment of time, money and/or goodwill in generating the consumer inquiries (i.e., leads). Another previously unrecognized problem in successfully realizing the above described approaches is the inability or difficulty of ensuring timely distribution of the leads to the best suited and available agents, providing the most timely response possible by that Agent, and ensuring that the consumer is satisfied that their needs were met by the Agent who serviced the lead.

Without a way to compensate the actual originator across the various possible scenarios, the collective benefit of sharing resources and/or network affiliation amongst one another for lead creation, distribution, and management, is minimized or lost altogether. In addition, without timely and independently confirmed follow through of the leads generated by the network, the percentage of leads that are successfully converted to actual sales remains very small, resulting in the lack of sufficient profit to implement the quality model needed to meet the evolving needs and demands of consumers using the Internet and/or other networks such as extranets and intranets. For example, statistics reported by the NAR show that only 50% of all leads generated in the real estate industry are responded to within 48 hours. The consumers who rely on the Internet typically want contact to occur no later than one hour after they make a request for more information.

One result of the issues raised above is a low conversion ratio of leads to sales, which may in some instance be under 10%. A low conversion ratio places at risk the current local agent's role in benefiting from leads generated by this new medium. Now with over 72% of all home buyers using the Internet to search for homes, it places their future viability in this changing market place at risk. This competitive obsolescence adversely affects the companies that the agents work for, and place these companies at risk of being unable to compete, and thus their very existence is uncertain, particularly as their agents go to work for their larger competitors who have invested in the costly adaptations needed to allow the agent to compete for the business of Internet using consumers. This allows the larger providers to grow, servicing the sophisticated consumers that the smaller providers leave behind.

Thus, one previously unrecognized problem with prior approaches is that such approaches do not identify the initial or original source of a lead. The previous approaches track the lead originator as the last Company the consumer came from, not the first Company the consumer visited. This leaves the originator of the actual lead unable to depend on compensation through a referral fee, thus breaking the model as an automated solution.

Another previously unrecognized problem with the prior approaches is the time and effort it takes on the part of the originating company/agent to record the referral, thus, many do not take the effort needed to do so.

Additionally, another previously unrecognized problem of prior approaches is that while such approaches provide for the lead being delivered to an agent, there is no agent's follow through confirmation or quality of service assessment. Such prior approaches provide for delivery of a lead to the agent, but lack the confirmation of the follow through in a timely and satisfactory fashion sufficient to redistribute the lead to another agent who can remedy the failed follow through by the Agent or in situations where the consumer has not been happy with the agent. Prior approaches also fail to ensure timely contact by an agent with the consumer because they distribute the lead to the agents in a linear or serial fashion, i.e., one at a time. This causes delays in response time, waiting for contact to be made to each Agent, one after the other, until a suitable agent is found who is available to service the lead. Ultimately these approaches do not resolve the failed follow through by the Agents because they stop at delivery only. These prior approaches do not ensure timely follow through; but only ensure timely delivery of the lead.

In one aspect, a method, system and article captures and tracks events. An event, for example, may take the form of a prospective consumer moving from company/agent A's product and/or service offerings, to company/agent B's product and/or service offerings. Other events may apply which may be distilled to a thumb-print image and tracked as the prospective consumer navigates between various goods and/or service offerings of a network of affiliated third party entities, for example, by Hyperlinking using the World Wide Web aspect of the Internet. The “event” becomes a point of entry for customized tracking, allowing an eventual consumer transaction to be automatically tracked back to the “event” and thus, tracked back to the originating entity (e.g., advertiser or company, etc.) which initially drew the consumer to the network of entities. This allows the originating party to be adequately and timely rewarded or compensated for driving the “lead” to the network of affiliated third parties.

In another aspect, a method, system and article automates the referral process by ensuring the delivery of the lead to the best suited agent who is available at the time. Such may be accomplished, for example, by transmitting the lead simultaneously to a number of agents (i.e., broadcasting), each of who have criteria in a profile that satisfies one or more particular search criteria. Broadcasting the lead in a multi-threaded fashion may achieve response times typically in the order of a few minutes, resulting in a “near time” response to the consumer. Once the lead is delivered, the potential consumer is contacted (e.g., phone call, email), if they have given permission to do so, and asked if the agent contacted them within the time required. The potential consumer may also be asked one more questions regarding the quality of service provided by the agent. The quality question may inquire directly or indirectly regarding whether the consumer was satisfied with the service they received by the agent who contacted them. If not, the consumer may elect to be contacted by another agent. The broadcast is then run again, omitting the previous agent from the agents notified by the broadcast. The agent is also omitted from any subsequent broadcasts made with respect to the particular lead and/or consumer. Following each broadcast, the same or a similar follow through inquiry of the consumer is made until the consumer is satisfied or requests that their inquiry be retired.

Current approaches are based on revenue models which do not yield sufficient profit to make an enterprise viable if they were to provide as complete and detailed of a solution as is possible using the approach disclosed herein. If existing approaches were to provide the service, processes, and technology disclosed herein, such approaches would be un-profitable with their current un-modified revenue models.

Unlike other approaches, the timely and satisfactory follow through with the consumer is independently ensured. This goes beyond just the timely delivery of the lead to the agent, since the current approach positively confirms that the consumer's needs are being met, rather than simply assuming such or never even appreciating that such an issue exists. If the consumer's needs are not met, this is addressed before the distribution of the lead is considered complete. Once a sale is made, compensation of the originator of the lead is achieved, regardless of how many intervening sites or contacts the consumer may have visited, thereby fostering a cooperative relationship between independent service providers affiliated into an online network. Collectively, the resulting profitable affiliation of like entities delivers a competitive advantage only previously available to the largest of competitors within the market. It delivers a unique affiliation and lead distribution model not available by any other known approach.

While the affiliation model and the distribution model can stand on their own as unique solutions, together they provide a unique synergistic approach to the above described problems.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment in which at least one exemplary embodiment may operate.

FIG. 2 is a functional block diagram of a computing system suitable for use in the networked environment of FIG. 1, according to one illustrated embodiment.

FIG. 3 is a flow diagram showing a high level method of facilitating lead referral, and distributing leads according to one illustrated embodiment.

FIG. 4 is a flow diagram showing an intermediate level method of processing leads according to one illustrated embodiment.

FIG. 5 is a flow diagram of a low level method of processing leads according to one illustrated embodiment.

FIGS. 6A-6C are a flow diagram of a low level method of distributing the lead to the best matching agents according to one illustrated embodiment.

FIG. 7 is a flow diagram of a low level method of handling a lead referral with a backlog queue and a referral queue according to one illustrated embodiment.

FIG. 8 is a flow diagram of a low level method of determining whether the agent contacted the lead and determining consumer satisfaction according to one illustrated embodiment.

### DETAILED DESCRIPTION

In the following description, certain specific details are set forth in order to provide a thorough understanding of various embodiments of the invention. However, one skilled in the relevant art will recognize that the invention may be practiced without one or more of these specific details, or with other methods, components, materials, etc. In other instances, well-known structures associated with networks, servers, clients, databases and computing systems have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

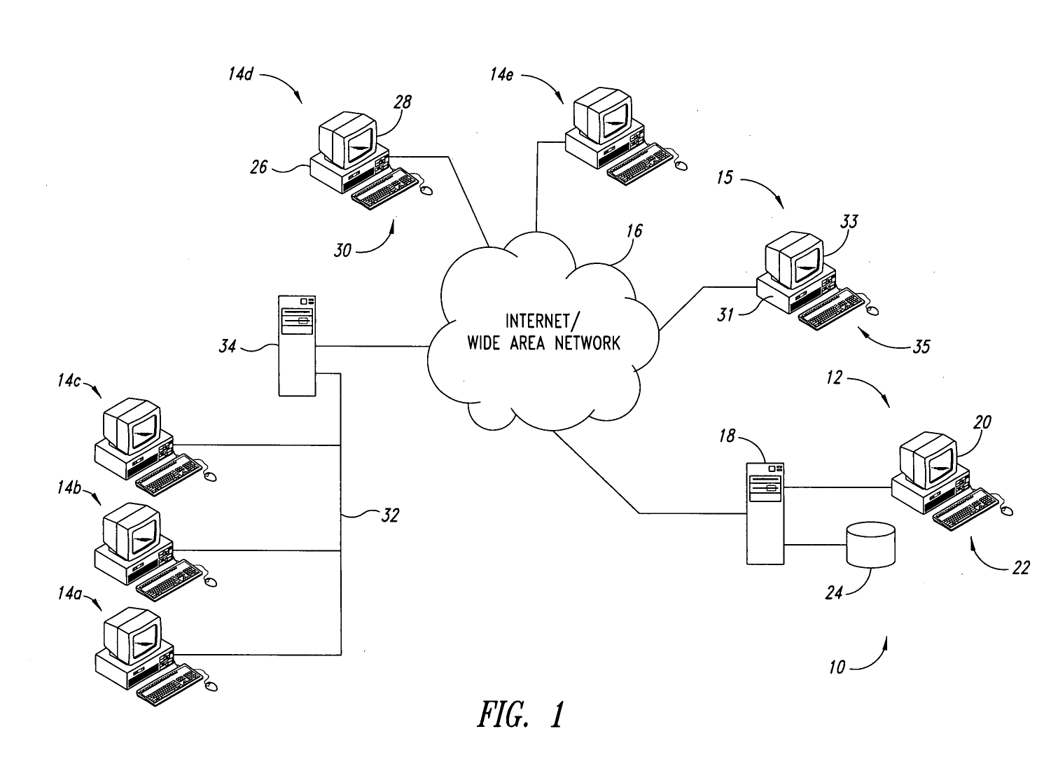

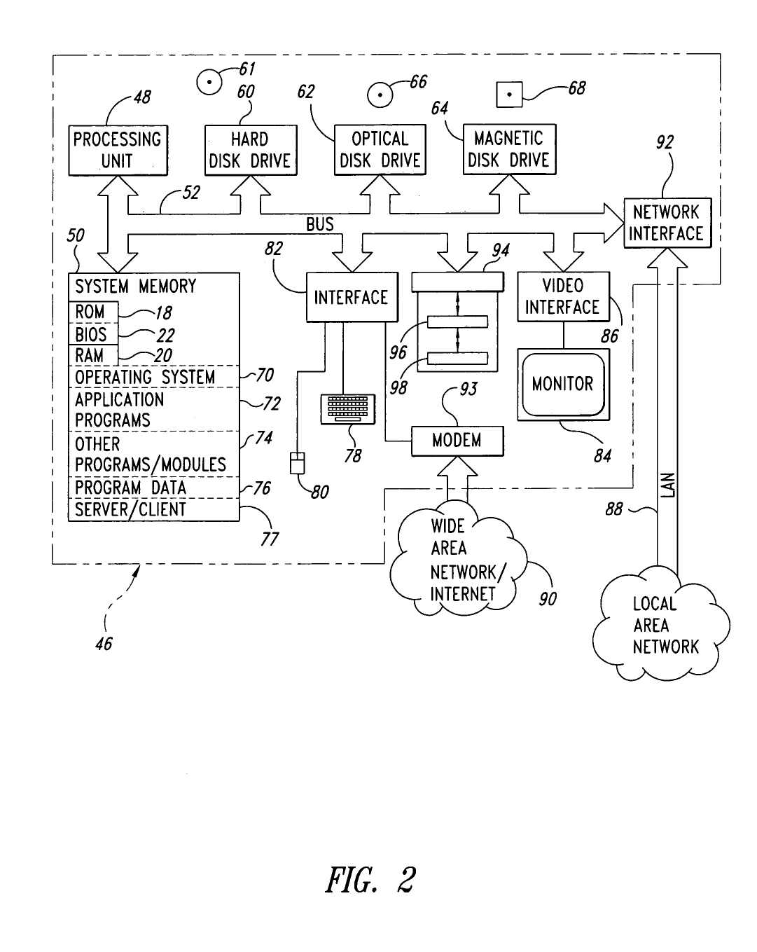

FIGS. 1 and 2, and the following discussion, provide a brief, general description of a suitable computing environment in which embodiments may be implemented. Although not required, embodiments will be described in the general context of computer-executable instructions, such as program application modules, objects, or macros being executed by a personal computer. Those skilled in the relevant art will appreciate that the invention can be practiced with other computing system configurations, including handheld devices, multiprocessor systems, microprocessor-based or programmable consumer electronics, network PCs, minicomputers, mainframe computers, and the like. Embodiments can be practiced in distributed computing environments where tasks or modules are performed by remote processing devices, which are linked through a communications network. In a distributed computing environment, program modules may be located in both local and remote memory storage devices.

In particular, FIG. 1 shows a networked environment 10 comprising a tracking computing system 12, and a number of third party computing systems 14a-14e, and a consumer computing system 15, all communicatively coupled via a Wide Area Network (WAN) such as the Internet 16. While represented as the Internet 16, the WAN may take the form of one or more extranets or intranets, or other types of networks, and can employ any of a variety of network architectures.

As described in more detail below, the tracking computing system 12 may take the form of a computer such as a server computer 18, and may optionally include a monitor 20 and one or more user input devices such as a keyboard, keypad, mouse, trackball, digitizing tablet 22, and/or touch screen display. The tracking computing system 12 may also include one or more data storage devices 24 storing one or more databases of information. While illustrated as being external to a housing of the server computer 18, one or more of the data storage devices 24 may be located internally in the housing of the server computer 18.

The third party computing systems 14a-14e may take the form of a computer 26 configured to function as a server and/or client, and may optionally include a monitor 28, and one or more user input devices such as a keyboard, keypad, mouse, trackball, digitizing tablet 30, and/or touch screen display. Some of the third party computing systems 14a-14c may be communicatively coupled to via a local or a wide area network 32, with access to the Internet 16 provide by a server 34. Such may be operated by or comprise a first third party affiliate with a respective Website/Webpage A. The third party computing system 14d may be operated or comprises a second third party affiliate with a respective Website/Webpage B. The third party computing system 14e may be operated by or comprises an originating third party affiliate with a respective Website/Webpage O. While only five third party computing systems 14a-14e are illustrated, typical environments 10 would provide an almost unlimited number of third party computing systems 15, since almost every business operated computing system in the world having access to the Internet could operate as a third party computing system 14a-14e.

The consumer computing system 15 may take the form of a computer such as a client computer 31, and may optionally include a monitor 33, and one or more user input devices such as a keyboard, keypad, mouse, trackball, digitizing tablet 35, and/or touch screen display. While only a single consumer computing system 15 is illustrated, typical environments 10 would provide an almost unlimited number of consumer computing systems 15, since almost every computing system in the world having access to the Internet could operate as a consumer computing system 15.

In particular FIG. 2 shows a conventional personal computer referred to herein as a computing system 46 that may be appropriate configured to function as either the tracking computing system 10 (FIG. 1), as one of the third party computing systems 14a-14e, or the consumer computing system 15.

In the computing system 46 includes a processor unit 48, a system memory 50 and a system bus 52 that couples various system components including the system memory 50 to the processing unit 48. The processing unit 48 may be any logical processing unit, such as one or more central processing units (CPUs), digital signal processors (DSPs), application-specific integrated circuits (ASIC), etc. Unless described otherwise, the construction and operation of the various blocks shown in FIG. 2 are of conventional design. As a result, such blocks need not be described in further detail herein, as they will be understood by those skilled in the relevant art.

The system bus 52 can employ any known bus structures or architectures, including a memory bus with memory controller, a peripheral bus, and/or a local bus. The system memory 50 includes read-only memory (“ROM”) 54 and random access memory (“RAM”) 56. A basic input/output system (“BIOS”) 58, which can form part of the ROM 54, contains basic routines that help transfer information between elements within the computing system 46, such as during startup.

The computing system 46 also includes one or more spinning media memories such as a hard disk drive 60 for reading from and writing to a hard disk 61, and an optical disk drive 62 and a magnetic disk drive 64 for reading from and writing to removable optical disks 66 and magnetic disks 68, respectively. The optical disk 66 can be a CD-ROM, while the magnetic disk 68 can be a magnetic floppy disk or diskette. The hard disk drive 60, optical disk drive 62 and magnetic disk drive 64 communicate with the processing unit 48 via the bus 52. The hard disk drive 60, optical disk drive 62 and magnetic disk drive 64 may include interfaces or controllers coupled between such drives and the bus 52, as is known by those skilled in the relevant art, for example via an IDE (i.e., Integrated Drive Electronics) interface. The drives 60, 62 and 64, and their associated computer-readable media 61, 66 and 68, provide nonvolatile storage of computer-readable instructions, data structures, program modules and other data for the computing system 46. Although the depicted computing system 46 employs hard disk 61, optical disk 66 and magnetic disk 68, those skilled in the relevant art will appreciate that other types of spinning media memory computer-readable media may be employed, such as, digital video disks (“DVD”), Bernoulli cartridges, etc. Those skilled in the relevant art will also appreciate that other types of computer-readable media that can store data accessible by a computer may be employed, for example, non-spinning media memories such as magnetic cassettes, flash memory cards, RAMs, ROMs, smart cards, etc.

Program modules can be stored in the system memory 50, such as an operating system 70, one or more application programs 72, other programs or modules 74, and program data 76. The applications programs 72 may include one or more programs for tracking lead origination, locating and/or notifying suitable agents, tracking the status of leads, and maintaining information about agents and other third party affiliates. The system memory 50 also includes one or more communications programs 77 for permitting the computing system 46 to access and exchange data with sources such as websites of the Internet, corporate intranets, or other networks, as well as other server applications on server computers. The communications program 77 may take the form of a server program, particularly where the computing system 46 implements the server computer 18 (FIG. 1) or third party computer 26. Alternatively, or additionally, the communications program may take the form of a browser program, particularly where the computing system 46 implements the consumer computer 31 (FIG. 1). The communications program 77 may be markup language based, such as hypertext markup language (“HTML”), and operate with markup languages that use syntactically delimited characters added to the data of a document to represent the structure of the document.

While shown in FIG. 2 as being stored in the system memory 50, the operating system 70, application programs 72, other program modules 74, program data 76 and communications program 77 can be stored on the hard disk 61 of the hard disk drive 60, the optical disk 66 and the optical disk drive 62 and/or the magnetic disk 68 of the magnetic disk drive 64.

A user can enter commands and information to the computing system 46 through input devices such as a keyboard 78 and a pointing device such as a mouse 80. Other input devices can include a microphone, joystick, game pad, scanner, etc. These and other input devices are connected to the processing unit 48 through an interface 82 such as a serial port interface that couples to the bus 52, although other interfaces such as a parallel port, a game port or a universal serial bus (“USB”) can be used. A monitor 84 or other display devices may be coupled to the bus 52 via video interface 86, such as a video adapter. The computing system 46 can include other output devices such as speakers, printers, etc.

The computing system 46 can operate in a networked environment 10 (FIG. 1) using logical connections to one or more remote computers. The computing system 46 may employ any known means of communications, such as through a local area network (“LAN”) 88 or a wide area network (“WAN”) or the Internet 90. Such networking environments are well known in enterprise-wide computer networks, intranets, extranets, and the Internet.

When used in a LAN networking environment, the computing system 46 is connected to the LAN 88 through an adapter or network interface 92 (communicatively linked to the bus 52). When used in a WAN networking environment, the computing system 46 often includes a modem 93 or other device for establishing communications over the WAN/Internet 90. The modem 93 is shown in FIG. 2 as communicatively linked between the interface 82 and the WAN/Internet 90. In a networked environment, program modules, application programs, or data, or portions thereof, can be stored in a server computer (not shown). Those skilled in the relevant art will readily recognize that the network connections shown in FIG. 2 are only some examples of establishing communication links between computers, and other communications links may be used, including wireless links.

The computing system 46 may include one or more interfaces such as slot 94 to allow the addition of devices 96, 98 either internally or externally to the computing system 46. For example, suitable interfaces may include ISA (i.e., Industry Standard Architecture), IDE, PCI (i.e., Personal Computer Interface) and/or AGP (i.e., Advance Graphics Processor) slot connectors for option cards, serial and/or parallel ports, USB ports (i.e., Universal Serial Bus), audio input/output (i.e., I/O) and MIDI/joystick connectors, and/or slots for memory.

The term “computer-readable medium” as used herein refers to any medium that participates in providing instructions to processor unit 48 for execution. Such a medium may take many forms, including but not limited to, non-volatile media, volatile media, and transmission media. Non-volatile media includes, for example, hard, optical or magnetic disks 61, 66, 68, respectively. Volatile media includes dynamic memory, such as system memory 50. Transmission media includes coaxial cables, copper wire and fiber optics, including the wires that comprise system bus 52. Transmission media can also take the form of acoustic or light waves, such as those generated during radio wave and infrared data communications.

Common forms of computer-readable media include, for example, floppy disk, flexible disk, hard disk, magnetic tape, or any other magnetic medium, CD-ROM, any other optical medium, punch cards, paper tape, any other physical medium with patterns of holes, RAM, PROM, EPROM, EEPROM, FLASH memory, any other memory chip or cartridge, a carrier wave as described hereinafter, or any other medium from which a computer can read.

Various forms of computer readable media may be involved in carrying one or more sequences of one or more instructions to processor unit 48 for execution. For example, the instructions may initially be carried on a magnetic disk of a remote computer. The remote computer can load the instructions into its dynamic memory and send the instructions over a telephone line using a modem. A modem 93 local to computer system 46 can receive the data on the telephone line and use an infrared transmitter to convert the data to an infrared signal. An infrared detector coupled to the system bus 52 can receive the data carried in the infrared signal and place the data on system bus 52. The system bus 52 carries the data to system memory 50, from which processor unit 48 retrieves and executes the instructions. The instructions received by system memory 50 may optionally be stored on storage device either before or after execution by processor unit 48.

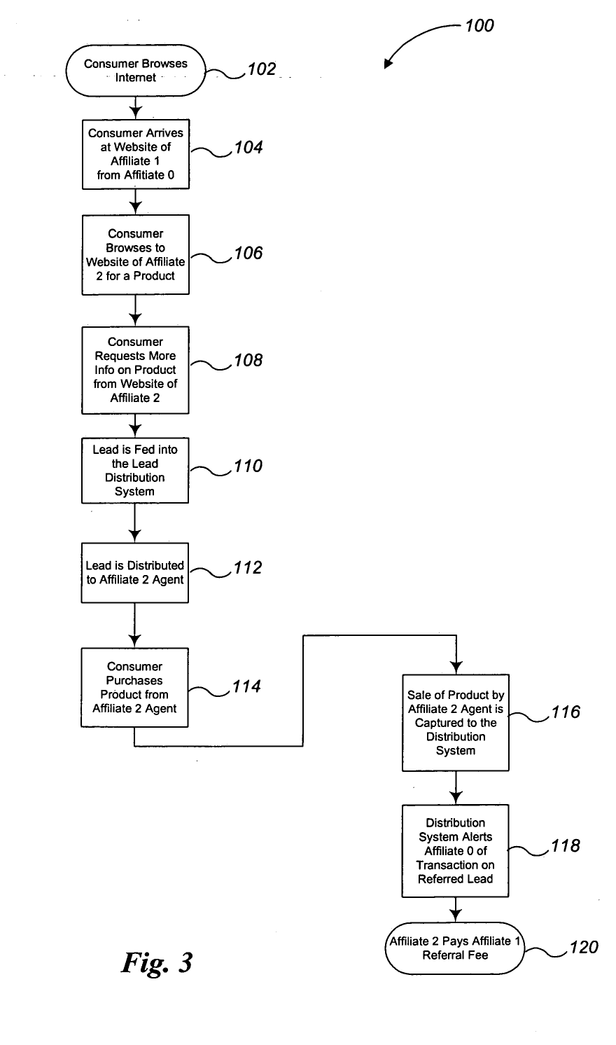

FIG. 3 is a flow diagram of a high level method 100 according to one illustrated embodiment.

At 102, a consumer browses the Internet, perhaps looking to purchase a good or service, perhaps looking for some piece of information or perhaps simply passing time. At 104, the consumer arrives at a Website/Webpage A of a first third party affiliate. The consumer may arrive at the Website/Webpage A from a previous Website/Webpage O operated by an originating third party affiliate that has invested in advertising their Webpage or Website O or that has other goodwill that initially attracted the consumer. The tracking computing system 12 causes a unique session identifier of the consumer browser session to be saved for later use, for example, in the database of data storage device 24 or as a cookie on the consumer's computing system 15 or the third party affiliate's computing system 14a-14e. Storing the unique session identifier at the database of data storage device 24 provides an enhanced level of security over the other options. Storing the unique session identifier on the third party affiliate's computing system 14a-14e, or even on the consumer's computing system 15 reduces the amount of network traffic, and allows the entity operating the tracking computing system 12 to offload the storage function which would otherwise be monumental.

At 106, the consumer continues browsing, reaching a Website/Webpage B operated by a second third party affiliate. The consumer may locate a good and/or service offered on the Website/Webpage B, for which the third party affiliate is a specialist in providing or which is competitively priced or has other desirable qualities. The browser session is automatically changed to Website/Webpage B, thus the consumer may, or may not, notice the change from Website/Webpage A to Website/Webpage B. This transfer of Websites/Webpages constitutes an “event” which is managed and tracked by the tracking computing system 12 and/or third party affiliate computing system 14a-14e within this example. This event is saved for later use, for example in the database of data storage device 24 or as a cookie on the consumer's computing system 15 or the third party affiliate's computing system 14a-14e. As discussed above, storing the information at the database of data storage device 24 provides an enhanced level of security over the other options. Storing the information at the third party affiliate's computing system 14a-14e, or even on the consumer's computing system 15 reduces the amount of network traffic, and allows the entity operating the tracking computing system 12 to offload the storage function which would otherwise be monumental.

At 108, the consumer requests more information, for example, via email, chat request or phone call. The request includes the capture by the tracking computing system 12 of the unique browser session identifier stored at 104. This unique browser session identifier links the online session and the tracked events resulting from it to this request. This is accomplished whether the request by the consumer is an online request or an offline request (e.g., via a phone call). At this point all tracked browser history is available for reporting as desired. The tracking computing system 12 may also capture additional information, such as contact information for the consumer, which can be used below at 110 to link those steps back to the unique browser session identifier.

At 110, the captured lead is fed into a lead distribution system via any number of means of communications means, for example, broadcasting or point casting using various communications channels such as wired or wireless communications including but not limited to email, telephone calls and/or messages, pager, and/or instant text messaging.

At 112, the lead is distributed to the available agent having criteria that best matches selected criteria as determined by the distribution process. As discussed in more detail below, the agent is selected by one or more criteria specified by the referring third party affiliate (originating and/or intervening third party affiliate), the entity for which the agent works, the entity providing the tracking service, and/or consumer. Consequently, the best matching agent is selected to assist the consumer with the request for more information, based on the details of the lead.

At 114, the consumer purchases product and/or service from Website/Webpage B associated with the second third party affiliate. The consumer may make the purchase in a conventional manner, for example, by entering requested data and making the desired selections typical of checkout procedures commonly encountered on retail Websites/Webpages.

At 116, the Website/Webpage B reports the sale to the tracking computing system 12, providing any one of the unique identifying data elements previously gathered, for example at 104 or 108. In this example those elements are either the unique browser session identifier and/or the additional information provided by the consumer at 108.

At 118, the tracking computing system 12 determines that the originating third party affiliate operating the Website/Webpage O was the originator of the lead (lead originator) and second third party affiliate operating the Website/Webpage B was the product/service provider. The tracking computing system 12 alerts the originating third party affiliate operating the Website/Webpage O of the results of the lead follow-up. Optionally, the tracking computing system 12 may alert intervening third party affiliates, for example the first third party affiliate operating the Website/Webpage A of the results of the lead follow-up, particular where compensation and/or award will be provided to one or more intervening third party affiliates.

At 120, the provider of the tracking services or other entity distributes a fee or other award to the originating third party affiliate operating Website/Webpage O, as compensation or acknowledgement for attracting consumer into the affiliated network via the Website/Webpage O. The provider of the tracking services or other entity may pay the fee or make the award from compensation provided by the second third party affiliate operating the Website/Webpage B in response to making the sale. Alternatively, the provider of the tracking services or other entity may pay the fee or make the award from compensation received form a participation fee paid by the second third party affiliate for participating in the third party affiliate network. While the provider of the tracking services has generally been discussed as a separate entity from the third party affiliates, such should not be considered limiting. In this sense, it is understood that the provider of the tracking services may also be one of the third party affiliates participating in the third party affiliation network. Additionally, the operators of intervening Websites/Webpages may also receive compensation and/or awards.

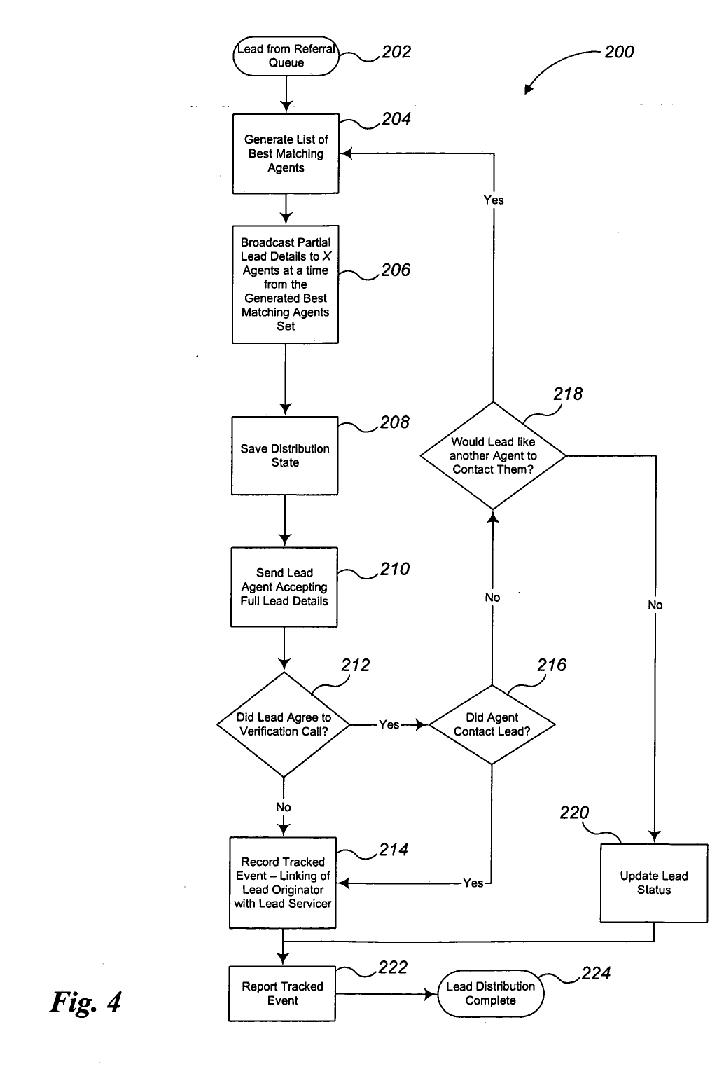

FIG. 4 is a flow diagram of an intermediate level method 200 of processing leads according to one illustrated embodiment.

At 202, a lead is received by a lead originator and processed into a lead referral queue. A lead can be received by the system through any of the following means, but not limited to: a phone call, a form filled out on a Website/Webpage, an email, Web services transaction/event, a fax, etc. The tracking computing system 12 enters the lead into the lead referral queue.

At 204, the tracking computing system generates a list of best matching agents, and/or next best matching agents based on various criteria. Each agent may have an administrative console to maintain an respective Agent Profile, where they can specify various criteria. A non-exhaustive list of examples may include: when the agent will accept leads, where the agent will accept leads, what kind of leads the agent will service/accept, and how the agent will accept leads. This process matches the lead with the best Agent(s) to service the Lead based on those specifics as provided by the lead. Such specifics may be generated by the affiliate providing the lead, by consumer, by the agents own company, and/or by the provider of the tracking services. In addition, the Agent selection criteria can include metrics data derived from the agent's past performance, including but not limited to: response time, follow-through, closing ratios, account status, overhead statistics, etc.

At 206, the lead is distributed to the best matching agents with enough information for them to determine if they are interested in contacting the lead.

In one embodiment, the lead may be point cast to the agents, one by one. In such an embodiment, the agents may be ordered based on the closeness of the match to the selection criteria. Each agent is given a fixed period of time in which to respond, otherwise the lead is point cast to the next agent.

In another embodiment, the lead is broadcast to at least two agents at a time, until one agent accepts the lead. This process can and should be run multi-threaded n processes at a time in parallel, until an agent accepts the lead. The number of threads used to broadcast the lead may be dynamic based on the number of agents best matching the selected criteria. This unique broadcast methodology distinguishes itself from a linear or serial approach (i.e., point cast to one agent at a time), and advantageously requires less time to find an agent to serve the consumer. This permits the consumer to be quickly serviced by the best suited agent.

At 208, the tracking computing system 12 saves the distribution state, for example, storing information about which best matching agents have been contacted about the lead and did not accept it, as well as, which agents the tracking computing system 12 was not able to contact, and/or which agents have not yet been contacted about the lead.

At 210, the tracking computing system 12 or third party affiliate that is providing the lead sends the agent that accepts the lead the full details regarding the lead, including, but not limited to, the lead contact information. The tracking computing system 12 may employ a fixed time period by which the full details regarding the lead must be provided to the agent. If a third party affiliate is providing the full details to the agent, then the failure to forward the full details regarding the lead within the time period may affect the compensation or reward to be received by the third party affiliate. Alternatively, if the tracking computing system is providing the full details to the agent, then the failure to forward the full details regarding the lead within the time period may affect the compensation paid to the entity providing the tracking services or third party affiliate network. For example, the agent or agent's company may be entitled to a refund of some portion of a fee paid to participate in the third party affiliate network.

At 212, it is determined whether the consumer to which the lead pertains agreed to a verification inquiry. At the time of inquiry the consumer is able to specify whether or not they will accept an inquiry regarding service, and may or may not be allowed to select a mode of communications for accepting such an inquiry, for example via phone call, email, and/or facsimile. The inquiry is for the purpose of confirming timely follow through of by the agent that accepts the lead, as well as the consumer's satisfaction with the service provided by the agent. This approval allows management of leads to be retained by the tracking computing system 12 and/or operator of the third party affiliated network. Therefore, if the agent has not called in the time required, or the consumer is not satisfied with the service provided, another Agent can be obtained to assist the consumer. This feature is unique, in that, the system goes beyond simply delivering a lead to an agent, by ensuring that the consumer's needs and expectations are being met using the consumer's own feedback. By tracking failures by agents to timely contact the consumer, this approach can provide a disincentive to agents accepting more leads than the agent can competently and timely handle.

At 214, the tracking computing system 12 links or associates the originator of the lead with the with agent who is servicing the lead. For example, the tracking computing system 12 can link or associate the originator of the lead with the agent by defining or storing a relationship between entries representing the originator and the agent in the database of data storage device 24 (FIG. 1).

At 216, it is determined whether the agent contacted the consumer to which the lead pertains. The consumer is automatically contacted via the tracking computing system 12 or personally contacted by a person who is not associated with the agent who accepted the lead. The inquiry verifies that the agent succeeded in contacting and assisting the consumer to the consumer's own satisfaction. This inquiry with the consumer is made using the mode of communications selected by the consumer at the time of their original inquiry if the consumer made such a selection.

At 218, if the agent did not contact the consumer to which the lead pertains, or if the consumer is not satisfied with the service provided by the agent, the consumer is asked whether they would like another agent to contact them.

If the consumer would like another agent to contact them, or where no contact has been made yet and the consumer still wishes to be contacted by an agent, the control returns to 204 to find the next best agent to serve the consumer represented by the lead. By selecting the next best agent, the previously selected agent is inherently removed from the process. The tracking computing system may additionally note that the agent should not be included in any new leads that correspond to the particular consumer, and/or may update selection criteria for the particular agent to reflect the dissatisfaction of the consumer.

If the consumer does not wish to be contacted by another agent, the not, then optionally an inquiry may be made if the consumer will authorize contact at a later time and the consumers desired form of communications for such contacts (e.g., email, phone call, etc.) At 220, the tracking computing system 12 updates the status of the lead to indicate that the lead is closed and the lead was not properly serviced by any agent. Updated data may include any future contact authorization and approved methods. The absence of authorization may be treated as an implied do-not-contact request. This data may be stored for future reporting metrics.

At 220, the tracking computing system 12 creates a report for the lead originator to notify the lead originator of the result of its originated lead. This report can be in the form of, but is not limited to, a digital transaction submitted over the Web to the lead originator's computing system 14a-14e, an email, a hard copy document mailed via conventional mail, a fax, etc.

At 224, the lead has either been distributed to an agent accepting the lead or the lead has declined further help and the distribution process of method 200 is complete.

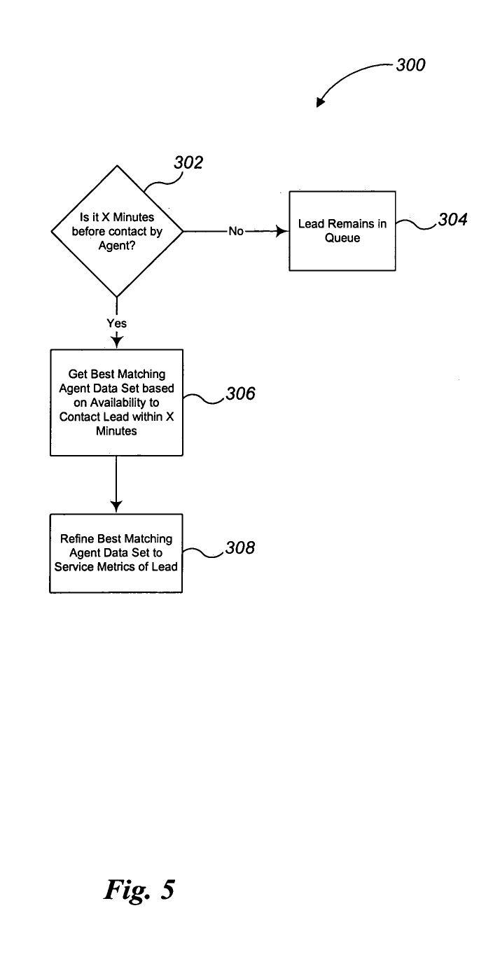

FIG. 5 is a flow diagram of a low level method 300 of processing a lead in accordance with 202 of the method 200 (FIG. 4) according to one illustrated embodiment.

At 302, the tracking computing system 12 determines if it is time for a lead to be queued for distribution. This helps insure that a lead is always matched to the agent best able to service the lead at the time contact is requested. It must be noted that time is needed to locate a suitable and available agent to contact the consumer identified by the lead at the time requested.

If it is determined at 302 that it is not yet time for a lead to be serviced, the lead is left in the queue at 304. Otherwise, at 306 the tracking computing system 12 gets the agent with the best matching criteria based on availability to contact the lead within the allotted time. In particular, the tracking computing system 12 determines all agents that are available to service the lead within the defined time period (e.g., 12 minutes) based on the preferences in the agents' profiles and the details provided with the lead.

At 308, the tracking computing system 12 refines the determined best matching agent set to the service metrics of the lead. Given all agents that are available to service a lead within the defined period, the tracking computing system 12 selects those which will be a best fit for the lead based on the lead details and the information saved in the profiles of the agents.

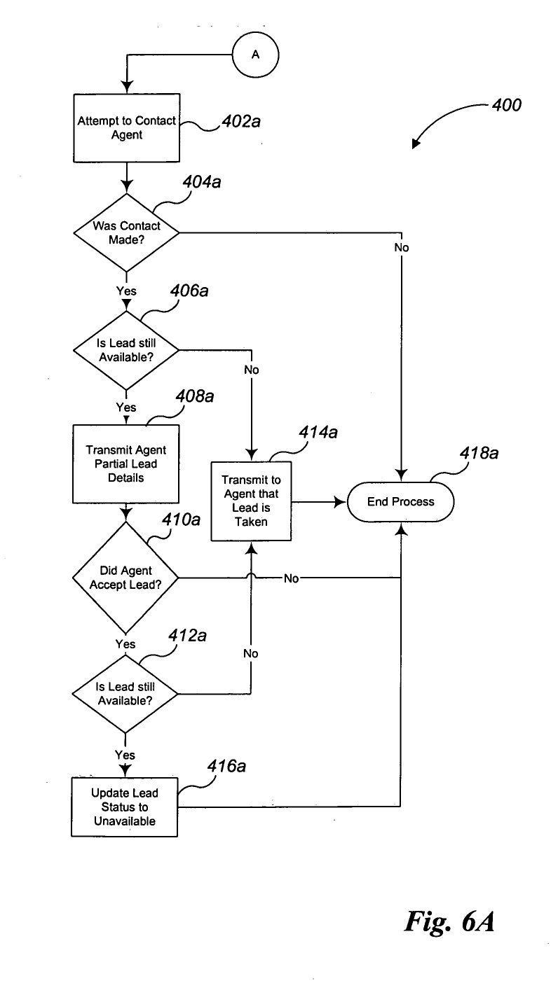

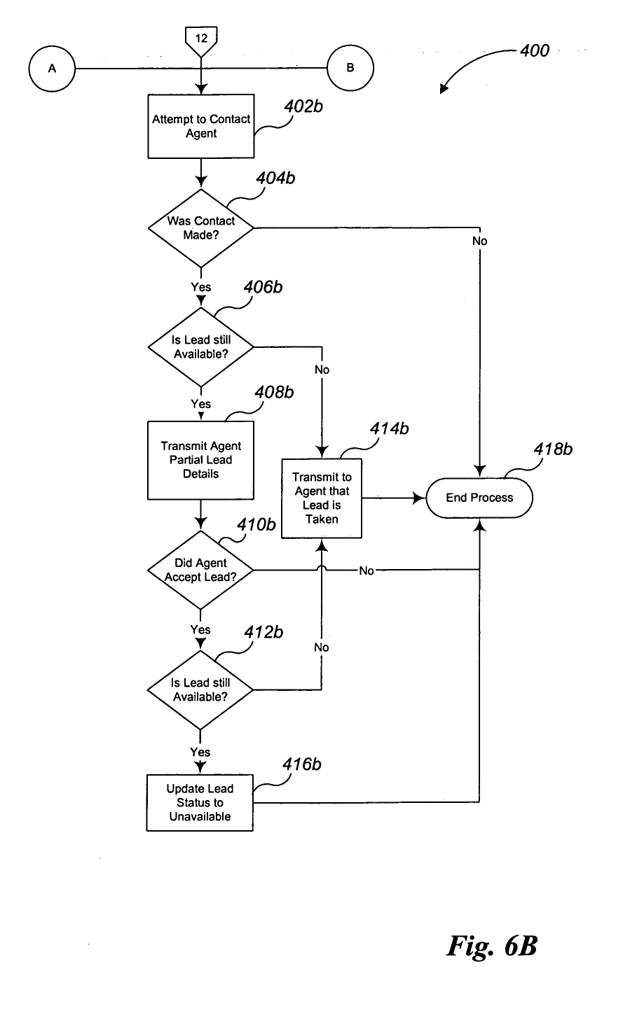

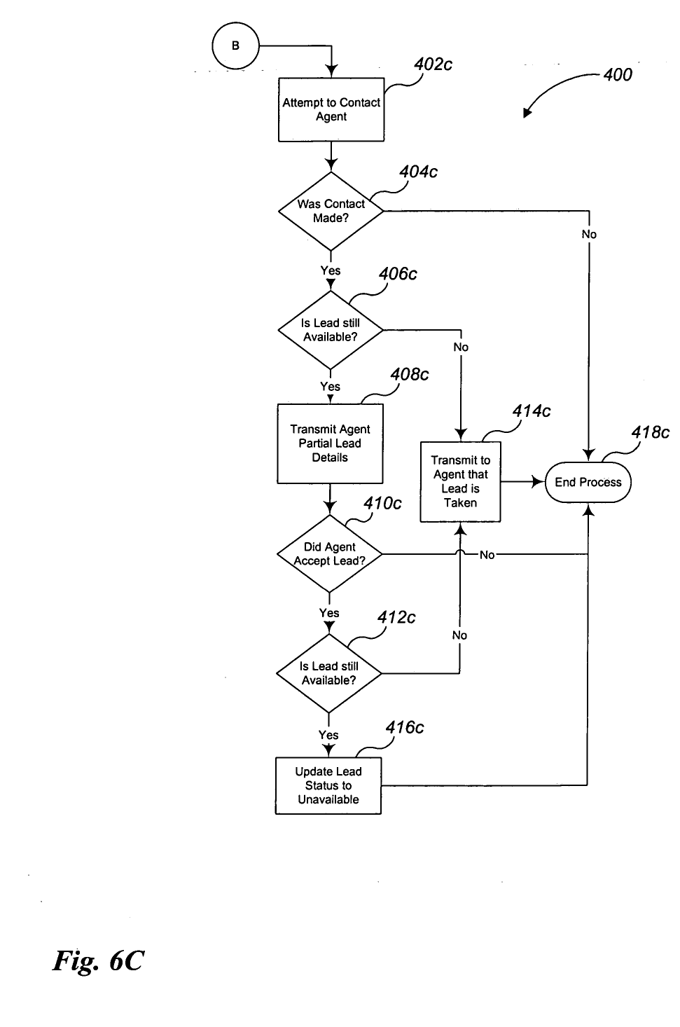

FIGS. 6A-6C are a flow diagram of a low level method 400 of distributing the lead to the best matching agents in accordance with 206 of method 200 (FIG. 4) according to one illustrated embodiment.

As illustrated the method shows a broadcast to three agents simultaneously or nearly simultaneously. The process for each of the agents is the same or similar so like acts will share a reference number and be distinguished by an alphabetic character appended to the reference number. It is to be understood that a broadcast typically may include transmission to more than three agents at once, or as few as two agents at once. The case of a point cast is illustrated by any single leg of the method 400, and will not be further illustrated or discussed for the sake of brevity.

At 402a-402c, the tracking computer system 12 or some entity not associated with the agent tries to contact the selected agent(s). Contact may be made by any communications channel, for example but is not limited to phone calls, text messages, email, facsimile, etc, and may be by multiple communications channels.

At 404a-404c, it is determined whether the contact was made with the selected agent(s). A 406a-406b, the tracking computing system 12 determines whether the lead is still available. This ensures that the lead has not been taken during the time that it took to contact the agent or during the time that it took to transmit the lead details to the agent after making contact.

At 408a-408c, the tracking computing system 12 transmits enough information to the agent so as to allow the agent to decide whether or not the agent would like to accept the lead. This information should not include personally identifiable information about the lead, just sufficient enough to make a decision. This information may, for example, include, general geographic area, type of goods and/or services, pricing information, etc.

At 410a-410b, the tracking computing system 12 determines whether agent will accept the lead and commit to servicing the lead within the defined period of time. At 412a-412c, the tracking computing system 12 can again determine whether the lead is still available in response to determining that an agent will accept the lead at 410a-410c.

If it is confirmed at 412a-412c that the lead is still available, the tracking computing system 12 lets the agent accepting the lead know that the lead is no longer available for them to accept. Otherwise, the tracking computing system 12 updates the status of the lead at 414a-414c, to indicate that the lead has been accepted by an agent. The method 400 terminates at 418a-418c.

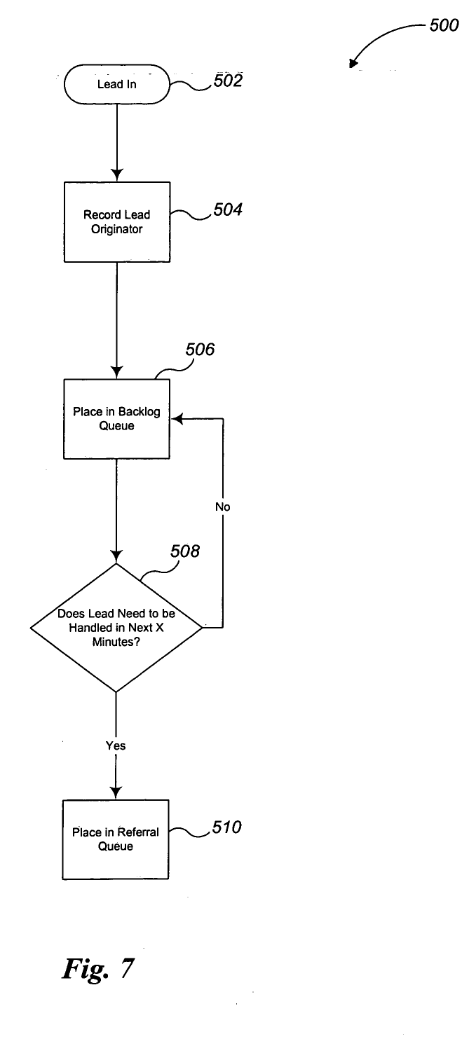

FIG. 7 is a flow diagram of a low level method 500 determining handling a lead referral and a lead queue in accordance with 202 of method 200 (FIG. 4) according to one illustrated embodiment.

At 502, the tracking computing system 12 receives a lead. At 504, tracking computing system 12 records the identity of the lead originator for example, in the database of data storage device 24. At 506, the tracking computing system 12 places the lead in a backlog queue, which may for example be stored in the database of data storage device 24 (FIG. 1). At 508, the tracking computing system 12 determines whether the lead needs to be handled within the next defined period of time. If tracking computing system 12 determines that the lead does not need to be handled in the next defined period of time, the tracking computing system 12 returns or leaves the lead to the backlog queue. Otherwise, the tracking computing system 12 places the lead in a referral queue, which may, for example be stored in the database of data storage device 24 (FIG. 1).

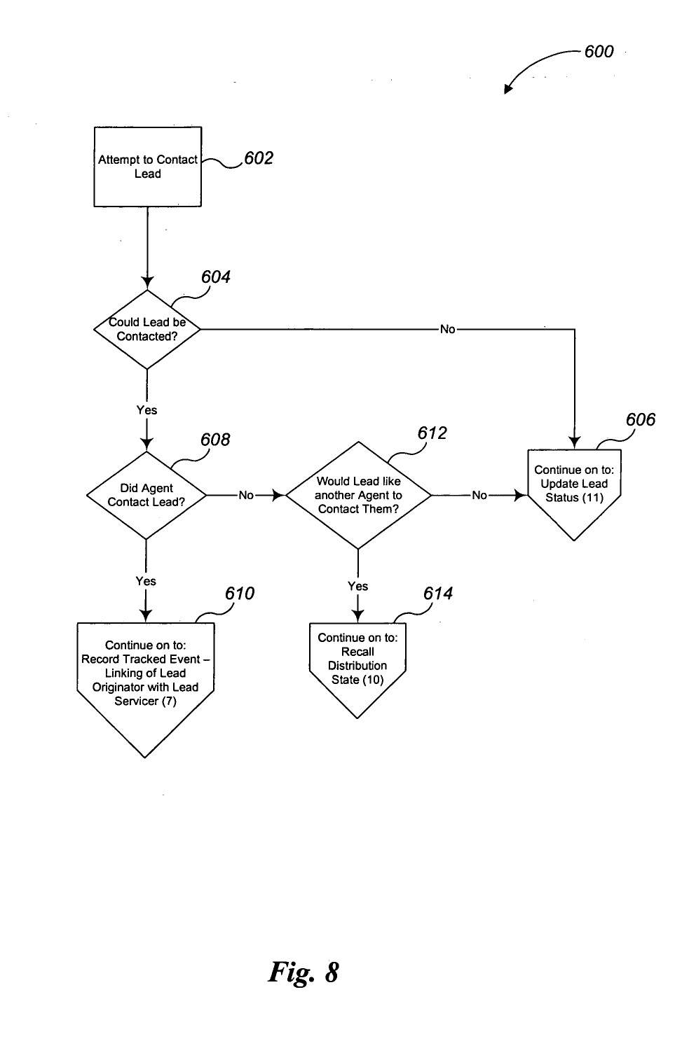

FIG. 8 is a flow diagram of a low level method 600 determining whether the agent contacted the lead and determining consumer satisfaction in accordance with 216 of method 200 (FIG. 4) according to one illustrated embodiment.

At 602, the tracking computer system 12 or some entity not associated with the agent tries to contact the consumer identified by the lead. Contact may be made by any communications channel, for example but is not limited to phone calls, text messages, email, facsimile, etc.

At 604, the tracking computer system 12 or the entity not associated with the agent determines whether consumer identified by the lead could be contacted. If it is determined that the consumer cannot be contacted, control passes to 606 to update the status of the lead, for example by returning to 220 of method 200 (FIG. 4).

If it is determined that the consumer can be contacted, it is determined at 608 whether the agent contacted the consumer. This may be done by asking the consumer during a phone call, or by emailing, text messaging or otherwise making an inquiry of the consumer.

If it is determined that the agent contacted the consumer, control passes to 610 where the lead originator is linked with the agent or agent's company, for example by returning to 214 of method 200 (FIG. 4). If it is determined that the agent did not contact the consumer, it is determined whether the consumer would like to be contacted by another agent at 612. If it is determined that the consumer does not wish to be contacted by another agent, control passes to 606 to update the status of the lead. Otherwise, control passes to 614 to select the next available agent, for example by returning to 204 of method 200 (FIG. 4) and omitting the previous agent from the search criteria, or by employing a saved list of previously selected agents.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to other methods, systems and articles for attributing compensation, credit or other awards, not necessarily the exemplary referral based system generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. provisional patent application Ser. No. 60/533306, filed Dec. 30, 2003 are incorporated herein by reference, in their entirety. Aspects of the invention can be modified, if necessary, to employ systems, circuits and concepts of the various patents, applications and publications to provide yet further embodiments of the invention.

These and other changes can be made to the invention in light of the above-detailed description. In general, in the following claims, the terms used should not be construed to limit the invention to the specific embodiments disclosed in the specification and the claims, but should be construed to include all methods, systems and articles that operate in accordance with the claims. Accordingly, the invention is not limited by the disclosure, but instead its scope is to be determined entirely by the following claims.

1. A method of facilitating the distribution of leads; the method comprising:
determining that a transaction has occurred between a consumer identified in a lead and a provider of a good and/or service;
determining an originating source for the lead that identified the consumer in the transaction where there has been at least one intervening referral of the lead between the originating source for the lead and the provider of the good and/or service; and
automatically notifying the originating source of the occurrence of the transaction.

2. The method of claim 1 wherein determining that a transaction has occurred between a consumer identified in a lead and a provider of a good and/or service comprises receiving an automatic notification from at least one of the provider and the consumer over a network.

3. The method of claim 1 wherein determining an originating source for the lead that identified the consumer in the transaction comprises tracking browser sessions as a consumer moves between Websites and/or Webpages associated with at least three different entities.

4. The method of claim 3 wherein the at least three different entities are part of an network of third party affiliates operated by a trusted entity.

5. The method of claim 1 wherein determining an originating source for the lead that identified the consumer in the transaction comprises storing a unique session identifier identifying a consumer browser session; storing a record of an event identifying a change in the consumer browser session and linking the unique session identifier with the transaction.

6. The method of claim 1, further comprising:
compensating the originating source for providing the lead in response to determining that the transaction has occurred between the consumer identified in the lead and the provider of the good and/or service.

7. The method of claim 1, further comprising:
receiving a lead from the originating source;
determining at least one third party affiliate suitable for responding to the lead;
notifying the at least one third party affiliate determined suitable for responding to the lead of the availability of the lead;
determining whether one of the at least one third party affiliate has accepted responsibility for contacting a consumer identified by the lead.

8. The method of claim 7, further comprising:
determining whether the third party affiliate who has accepted responsibility has contacted the consumer identified by the lead within a defined period of time; and
notifying at least another third party affiliate of the availability of the lead if the third party affiliate who has accepted responsibility has not contacted the consumer identified by the lead within the defined period of time.

9. A system for facilitating the distribution of leads; the system comprising:
at least one processor;
at least one database coupled to the processor for storing and retrieving information; and
at least one processor readable medium storing instructions for causing the at least one processor to facilitate the distribution of leads by:
determining that a transaction has occurred between a consumer identified in a lead and a provider of a good and/or service;
determining an originating source for the lead that identified the consumer in the transaction where there has been at least one intervening referral of the lead between the originating source for the lead and the provider of the good and/or service; and
automatically notifying the originating source of the occurrence of the transaction.

10. A method of distributing leads, the method comprising:
in response to a lead, automatically determining a first set of at least two agents suitable for servicing the lead; and
broadcasting notice of the lead to the at least two agents of the first set without first waiting for a response from either one of the at least two agents.

11. The method of claim 10 wherein broadcasting notice of the lead to the at least two agents of the first set without first waiting for a response from either one of the at least two agents comprises transmitting notice to each of the leads approximately simultaneously.

12. The method of claim 10 wherein automatically determining a first set at least two agents suitable for servicing the lead comprises determining an identifier of each of a number of agents having criteria matching a first number of criteria specified in the lead.

13. The method of claim 10 wherein automatically determining a first set of at least two agents suitable for servicing the lead comprises determining an identifier of each of a number of agents having criteria matching a number of criteria specified in the lead by a referring agent that is providing the lead.

14. The method of claim 10 wherein automatically determining a first set of at least two agents suitable for servicing the lead comprises determining an identifier of each of a number of agents having criteria matching a number of criteria specified in the lead by a consumer identified by the lead.

15. The method of claim 10 wherein automatically determining a first set of at least two agents suitable for servicing the lead comprises determining an identifier of each of a number of agents having criteria matching a number of criteria specified in the lead by a provider of a third party affiliation network over which the lead is provided.

16. The method of claim 10, further comprising:
receiving a response from a first one of the agents of the first set of agents;
determining whether the lead is still available; and
providing further information regarding the lead to the first one of the agents to respond if the lead is still available.

17. The method of claim 16, further comprising:
waiting a defined period of time after providing further information regarding the lead to the first one of the agents to respond;
contacting a consumer identified by the lead; and
determining whether the first agent to respond has contacted the consumer identified by the lead.

18. The method of claim 17, further comprising:
in response to determining that the first agent to respond has not contacted the consumer, determining whether the consumer identified by the lead would like to be contacted by another agent;
in response to determining that the consumer identified by the lead would like to be contacted by another agent, automatically determining a second set of at least two agents suitable for servicing the lead;
broadcasting notice of the lead to the at least two agents of the second set without first waiting for a response from either one of the at least two agents; and
notifying the first agent to respond that the lead is no longer available.

19. The method of claim 17, further comprising:
in response to determining that the first agent to respond has contacted the consumer identified by the lead, determining whether the consumer identified by the lead is satisfied with a performance of the first agent to respond.

20. The method of claim 16, further comprising:
identifying the lead as being no longer available after providing further information regarding the lead to the first one of the agents to respond.

21. The method of claim 20, further comprising:
receiving a response a second one of the agents of the first set of agents;
determining whether the lead is still available; and
notifying the second one of the agents that the lead is no longer available.

22. The method of claim 10, further comprising:
waiting a period of time after broadcasting notice of the lead to the at least two agents;
determining that none of the agents of the first set of agents responded to the broadcast within the period of time;
in response to the determination, automatically determining a second set of at least two new agents suitable for servicing the lead; and
broadcasting notice of the lead to the at least two agents of the second set of agents without first waiting for a response from either one of the at least two agents of the second set of agents.

23. The method of claim 22 wherein automatically determining a first set at least two agents suitable for servicing the lead comprises determining an identifier of each of a number of agents having criteria matching a second number of criteria specified in the lead, the second number not greater than the first number.

24. A system for distributing leads, the system comprising:
at least one processor;
at least one database communicatively coupled to the processor for storing and retrieving information; and
at least one processor readable medium storing instructions for causing the at least one processor to distribute leads by:
in response to a lead, automatically determining a first set of at least two agents suitable for servicing the lead; and
broadcasting notice of the lead to the at least two agents of the first set without first waiting for a response from either one of the at least two agents.

25. The system of claim 24 wherein the at least one processor readable medium stores instructions for causing the at least one processor to automatically determine the first set at least two agents suitable for servicing the lead by determining an identifier of each of a number of agents having criteria matching a first number of criteria specified in the lead.

26. The system of claim 24 wherein the at least one processor readable medium stores instructions for causing the at least one processor to distribute leads, further by:
receiving a response from a first one of the agents of the first set of agents;
determining whether the lead is still available; and
providing further information regarding the lead to the first one of the agents to respond if the lead is still available.

27. The system of claim 26 wherein the at least one processor readable medium stores instructions for causing the at least one processor to distribute leads, further by:
in response to determining after a defined period of time that the consumer identified by the lead would like to be contacted by another agent, automatically determining a second set of at least two agents suitable for servicing the lead;
broadcasting notice of the lead to the at least two agents of the second set without first waiting for a response from either one of the at least two agents; and
notifying the first agent to respond that the lead is no longer available.

28. The system of claim 27 wherein the at least one processor readable medium stores instructions for causing the at least one processor to distribute leads, further by:
receiving a response a second one of the agents of the first set of agents;
determining whether the lead is still available; and
notifying the second one of the agents that the lead is no longer available.
